(19) United States
(12) Patent Application Publication
(10) Pub. No.: US 2026/0204896 A1
(43) Pub. Date: Jul. 16, 2026

(54) PROTECTION CIRCUIT AND EMBEDDED MULTI-CHIP SYSTEM

(71) Applicant: INDUSTRIAL TECHNOLOGY RESEARCH INSTITUTE, Hsinchu (TW)

(72) Inventors: Yi-Hui WEI, Taichung City (TW); Jie ZHANG, New Taipei City (TW); Ya-Wen YANG, Hsinchu City (TW); Sih-Han LI, New Taipei City (TW)

(73) Assignee: INDUSTRIAL TECHNOLOGY RESEARCH INSTITUTE, Hsinchu (TW)

(21) Appl. No.: 19/094,087

(22) Filed: Mar. 28, 2025

(30) Foreign Application Priority Data
Jan. 16, 2025 (TW) 114101772

(51) Int. Cl. H02H 9/00; G05F 1/46; G05F 1/567; G05F 1/569; H02H 1/04

(52) U.S. Cl. CPC H02H 9/001; G05F 1/468; G05F 1/567; G05F 1/569; H02H 1/043

(57) ABSTRACT

A protection circuit includes a first transistor and a first comparator. The first transistor has a first terminal, a second terminal and a control terminal, and is configured to receive an input signal through the first terminal and output an output signal through the second terminal in a conducting state. An input terminal of the first comparator is coupled to the first terminal of the first transistor, another input terminal of the first comparator is configured to receive a first reference signal, and an output terminal of the first comparator is coupled to the control terminal of the first transistor. The first comparator is configured to output a first comparison signal according to a comparison result between the reference signal and the input signal. An embedded multi-chip system includes a protection circuit, a low dropout regulator and a switch control circuit.

### CROSS-REFERENCE TO RELATED APPLICATIONS

The present application is based on, and claims priority from, Taiwan (International) Application Serial Number 114101772, filed on January 16^{th}, 2025, the disclosure of which is hereby incorporated by reference herein in its entirety.

### BACKGROUND

### Technical Field

This disclosure relates to a protection circuit and an embedded multi-chip system.

### Related Art

Nowadays, at the moment of a power source module is turned on for startup, it will output a startup transient voltage, resulting in a risk of damage to the back-end circuit. Therefore, a corresponding protection mechanism is required to perform a protection on the back-end circuit. Specifically, to the miniaturized system, the impact degree of this transient voltage may be more significant because miniaturized components (such as chips) may tend to have lower tolerance to high voltage and high current, and easier to happen damage due to transient voltage exposure.

### SUMMARY

According to an embodiment of this disclosure, a protection circuit comprises a first transistor and a first comparator. The first transistor has a first terminal, a second terminal and a control terminal, and is configured to receive an input signal through the first terminal, and output an output signal through the second terminal in a conducting state. An input terminal of the first comparator is coupled to the first terminal of the first transistor, another input terminal of the first comparator is configured to receive a first reference signal, an output terminal of the first comparator is coupled to the control terminal of the first transistor, and the first comparator is configured to output a first comparison signal according to a comparison result between the first reference signal and the input signal.

According to another embodiment of this disclosure, an embedded multi-chip system comprises the protection circuit, a low dropout regulator and a switch control circuit. The low dropout regulator is coupled to a battery, and is configured to generate and provide the input signal to the first terminal of the first transistor of the protection circuit. The switch control circuit is coupled to the protection circuit, and is configured to control at least one switch element according to the output signal.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a functional block diagram of a protection circuit according to an embodiment of the present disclosure;

FIG. 2 is a circuit schematic diagram of a protection circuit according to another embodiment of the present disclosure;

FIG. 3 is a functional block diagram of a protection circuit according to still another embodiment of the present disclosure;

FIG. 4 is a circuit schematic diagram of a protection circuit according to yet another embodiment of the present disclosure;

FIG. 5 is a circuit schematic diagram of a protection circuit according to still another embodiment of the present disclosure;

FIG. 6 schematically illustrates a response relationship among a power-on signal, an output signal, and an activation signal of the protection circuit of the embodiments shown in FIG. 4 and FIG. 5; and

FIG. 7 is a functional block diagram of an embedded multi-chip system according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

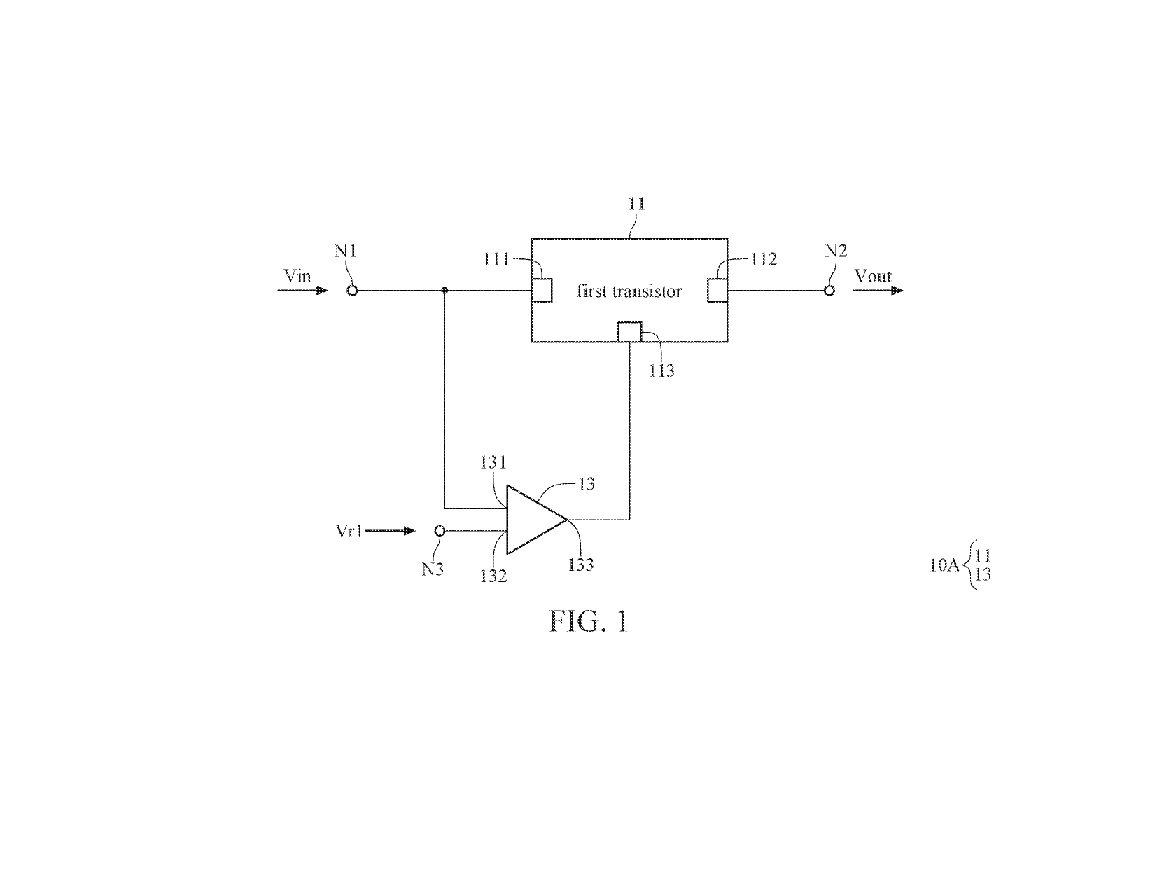

Please refer to FIG. 1, which is a functional block diagram of a protection circuit 10A according to an embodiment of the present disclosure. As shown in FIG. 1, the protection circuit 10A includes a first transistor 11 and a first comparator 13. The first transistor 11 has a first terminal 111, a second terminal 112 and a control terminal 113. The first transistor 11 may be configured to receive an input signal Vin through the first terminal 111, and output an output signal Vout through the second terminal 112 in a conducting state. An input terminal 131 of the first comparator 13 is electrically connected to the first terminal 111 of the first transistor 11, and another input terminal 132 of the first comparator 13 may be configured to receive a first reference signal Vr1. The output terminal 133 of the first comparator 13 is electrically connected to the control terminal 113 of the first transistor 11, and the first comparator 13 may be configured to output a first comparison signal according to the comparison result between the first reference signal Vr1 and the input signal Vin. More specifically, according to the aforementioned first comparison signal, the conducting state or non-conducting state of the first transistor 11 may be controlled.

In this embodiment, the first transistor 11 may control whether conduction occurs between the first terminal 111 and the second terminal 112 via the voltage at the control terminal 113, and corresponding to the aforementioned conducting state or non-conducting state. In some embodiments, the first transistor 11 may be a metal oxide semiconductor field effect transistor (MOSFET), where the first terminal 111 and the second terminal 112 may respectively be one of a source and a drain, and the control terminal 113 may be a gate. In other embodiments, the first transistor 11 may be a bipolar junction transistor (BJT), where the first terminal 111 and the second terminal 112 may respectively be one of a collector and an emitter, and the control terminal 113 may be a base, but the disclosure is not limited thereto. More specifically, the first comparator 13 may be configured to generate the first comparison signal according to the comparison result between the input signal Vin and the first reference signal Vr1 to control the first transistor 11 to enter a conducting state or non-conducting state. In some embodiments, the protection circuit 10A has a terminal N1 that provides the input signal Vin, and the terminal N1 may be electrically connected to an input power source. For example, the terminal N1 may be coupled to a low dropout regulator (LDO), and be provided with the input signal Vin by the aforementioned low dropout regulator. In some embodiments, the protection circuit 10A further includes a terminal N2, and the terminal N2 may be electrically connected to a back-end circuit (not shown). For example, the back-end circuit may be a sensor, a driver circuit, a display module, a storage device, an embedded system, any logic element or load combination thereof, but the disclosure is not limited thereto. The aforementioned back-end circuit may output an output signal Vout. In some embodiments, the protection circuit 10A further includes a terminal N3, the terminal N3 may be electrically connected to any reference source (not shown), and the first reference signal Vr1 is received from the aforementioned reference source to provide the first reference signal Vr1 to the input terminal 132 of the first comparator 13.

The protection circuit of the present disclosure may be applicable for various application scenarios. For example, in the field of the embedded system (a packaged chip), to further miniaturize the system, the power source configured to provide power for the entire packaged chip may be integrated into the package substrate. For example, the power source may be the aforementioned low dropout regulator (LDO). After integrating a low dropout regulator into the package substrate, though the embedded system may directly provide power to each electronic component within the system to achieve system miniaturization, at the moment the low dropout regulator is activated, a transient voltage is generated, which may damage the back-end circuit electrically connected to the output terminal of low dropout regulator. Therefore, a protective mechanism is required for isolation. In view of this, the protection circuit of the present disclosure is applicable for a miniaturized system, to perform protection for the miniaturized component of the back-end circuit against the risk of transient voltage damage.

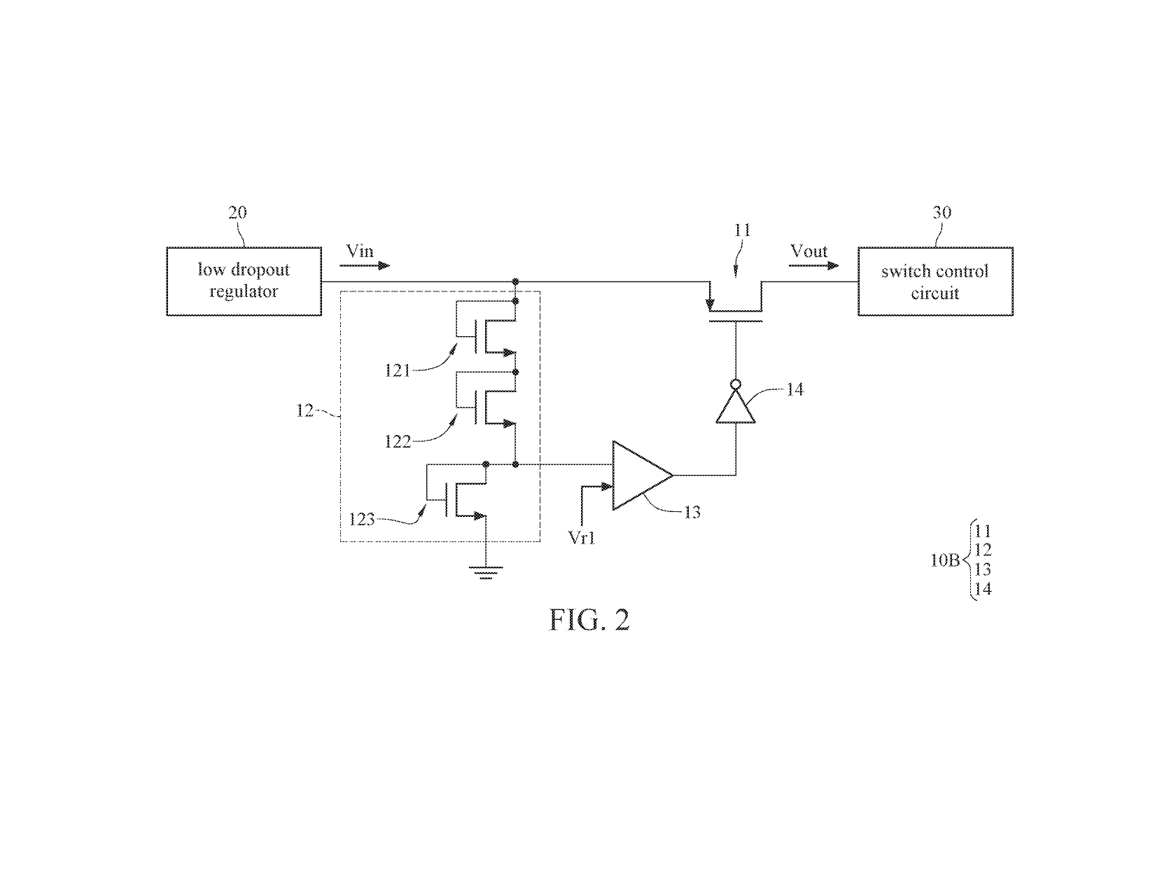

Please refer to FIG. 2, which is a circuit schematic diagram of a protection circuit 10B according to another embodiment of the present disclosure. As shown in FIG. 2, it is worth noting that the difference between this embodiment and the embodiment in FIG. 1 is that the terminal N1 of the protection circuit 10B may be electrically connected to a low dropout regulator 20, and the terminal N2 of the protection circuit 10B may be electrically connected to a switch control circuit 30. The protection circuit 10B may also optionally include a first voltage-dividing sub-circuit 12, which is connected to the first terminal 111 of the first transistor 11. The input signal Vin generated by the low dropout regulator 20 may be provided to the first transistor 11 and the first voltage-dividing sub-circuit 12, and the first voltage-dividing sub-circuit 12 may be configured to perform division on the input signal Vin. In some embodiments, the first voltage-dividing sub-circuit 12 may include a plurality of voltage-dividing elements (e.g., resistors or transistors), and the first comparator 13 is electrically connected to the aforementioned plurality of voltage-dividing elements, but the disclosure is not limited thereto. More specifically, these voltage-dividing elements may be a plurality of voltage-dividing transistors 121~123 that are electrically connected to each other (e.g., in series or parallel to achieve a voltage division effect), and the input terminal 131 of the first comparator 13 is electrically connected between these voltage-dividing transistors 121~123. For example, the first comparator 13 in the embodiment of FIG. 2 is electrically connected between voltage-dividing transistor 122 and voltage-dividing transistor 123 via input terminal 131 to perform division on the input signal Vin. In some embodiments, the number and the circuit configuration of voltage-dividing transistors in the first voltage-dividing sub-circuit 12 are not limited to this, and may be configured according to the actual requirement. In some embodiments, in an example where the voltage-dividing transistors are metal-oxide-semiconductor field-effect transistors (MOSFET), the gate and drain of each of these voltage-dividing transistors 121~123 are electrically connected to each other. This connection method causes each of the voltage-dividing transistors 121~123 to operate in the saturation region, and each of the voltage-dividing transistors 121~123 may produce a voltage division effect through series connection. It is worth noting that the first voltage-dividing sub-circuit 12 may also be implemented by other voltage-dividing elements, and the disclosure is not limited thereto. For example, the first voltage-dividing sub-circuit 12 may include a plurality of series-connected resistors, and the input terminal 131 of the first comparator 13 is electrically connected to the aforementioned series-connected resistors. It is worth noting that the first voltage-dividing sub-circuit 12 is designed for the area required by the aforementioned series-connected voltage-dividing transistors 121~123, and said area may be smaller than the area required by series-connected resistors.

Please refer to both FIG. 1 and FIG. 2. In some embodiments, the first comparator 13 may receive the input signal Vin, either voltage-divided or non-voltage-divided, through the input terminal 131, and receive the first reference signal Vr1 through the input terminal 132. Then, the first comparator 13 may generate a first comparison signal according to the comparison result between the voltage-divided or non-voltage-divided input signal Vin and the first reference signal Vr1. The first transistor 11 may be controlled by the first comparison signal to enter the conducting state or non-conducting state. Specifically, when the low dropout regulator 20 is initially activated, the low dropout regulator 20 may generate a higher transient voltage. At this moment, the first comparator 13 may determine that the voltage value of the voltage-divided or non-voltage-divided input signal Vin is higher than the voltage value of the first reference signal Vr1, thereby generating a first comparison signal that controls the first transistor 11 to enter a non-conducting state. Subsequently, after the low dropout regulator 20 is activated for a period of time, the voltage value of the low dropout regulator 20 reaches a stable voltage, meaning that the transient voltage in the input signal Vin has disappeared. At this point, the first comparator 13 may determine that the voltage value of the voltage-divided or non-voltage-divided input signal Vin is lower than the voltage value of the first reference signal Vr1, thereby generating a first comparison signal that controls the first transistor 11 to enter a conducting state. In this way, the transient voltage generated by the low dropout regulator 20 at the moment of power-on may be blocked, preventing instantaneous high voltage from damaging the back-end circuit and achieving the purpose of protecting the back-end switch control circuit 30.

Additionally, in some embodiments, the protection circuit 10B may further optionally include a logic element 14. The logic element 14 may be electrically connected to the output terminal 133 of the first comparator 13 and the control terminal 113 of the first transistor 11, and the logic element 14 may be configured to control the first transistor 11 to enter either the conducting state or the non-conducting state according to the first comparison signal. For example, the logic element 14 may be an inverter, and the output signal of the aforementioned inverter is opposite to the first comparison signal of the first comparator 13. That is: the output signal of the inverter may be "0" when the first comparison signal is "1"; the output signal of the inverter may be "1" when the first comparison signal is "0". Thus, the protection circuit 10B may more conveniently use the digital logic way to control the first transistor 11 to enter the conducting state or non-conducting state.

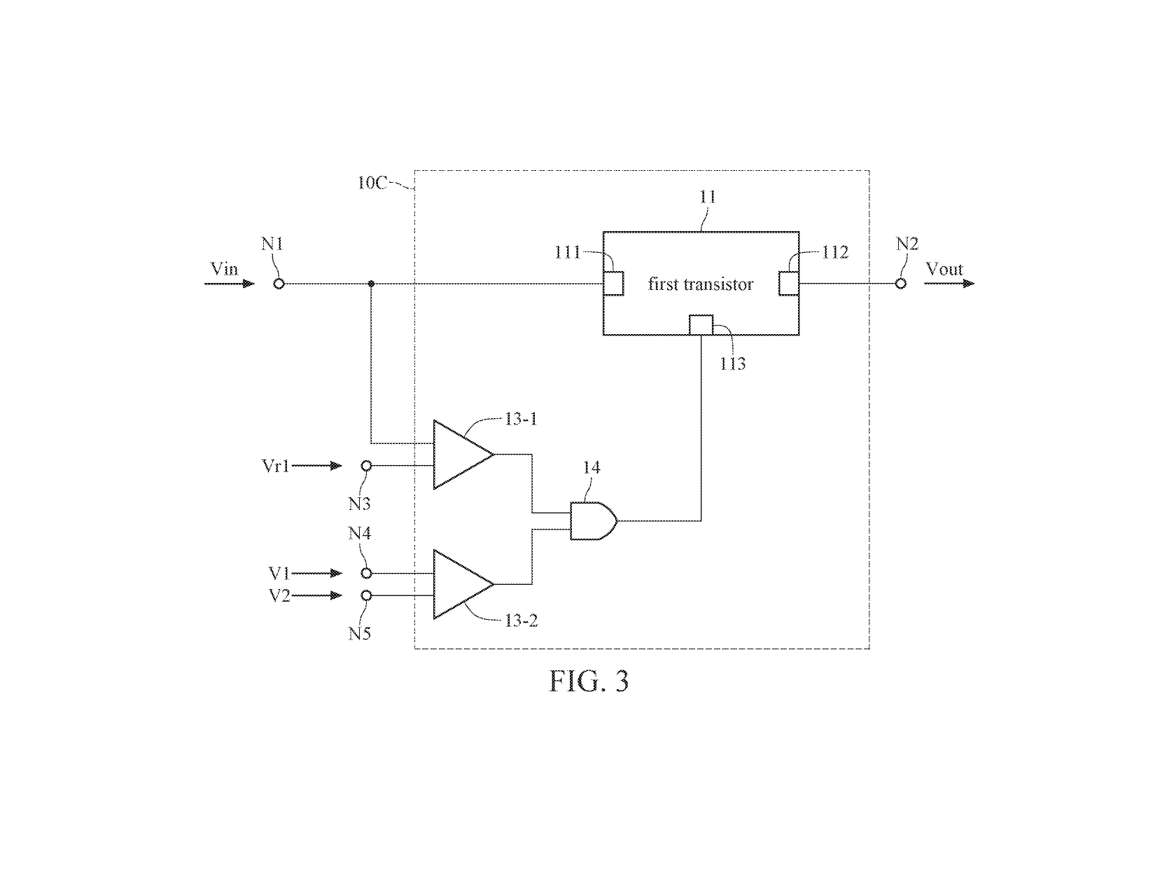

Please refer to FIG. 3, which is a functional block diagram of a protection circuit 10C according to still another embodiment of the present disclosure. It should be noted that the embodiment in FIG. 3 follows the component numbering and part of the content from the embodiments in FIG. 1 and FIG. 2, wherein identical or similar reference numbers indicate the same or similar components, and redundant explanations of the same technical content are omitted. The omitted part of descriptions may be referred to the aforementioned embodiments and not be repeated here. As shown in FIG. 3, in addition to the aforementioned first transistor 11 and the first comparator 13-1, the protection circuit 10C may further optionally include a second comparator 13-2 and a logic element 14. In some embodiments, the logic element 14 may be an AND gate, and the output terminal of the first comparator 13-1 and the output terminal of the second comparator 13-2 may be respectively electrically connected to two input terminals of the logic element 14. The output terminal of the logic element 14 is electrically connected to the control terminal 113 of the first transistor 11, and the logic element 14 is configured to control the first transistor 11 to enter either the conducting state or non-conducting state according to the comparison result between the first comparison signal of the first comparator 13-1 and the second comparison signal of the second comparator 13-2. In some embodiments, the logic element 14 may also be other logic elements than AND gate, for example: an OR gate, NOT gate, NAND gate, NOR gate, or any combination of logic elements, and it may be designed according to actual requirements, but the disclosure is not limited thereto.

Please refer to FIG. 1 to FIG. 3. In the embodiments shown in FIG. 1 and FIG. 2 described above, the first transistor 11 may be controlled to enter a conducting state or non-conducting state solely based on the comparison result of the first comparator 13. In contrast, in the embodiment of FIG. 3 described above, the logic element 14 may make an overall determination according to a plurality of judgment conditions (e.g., the comparison result of the first comparator 13-1 and the comparison result of the second comparator 13-2), to control the first transistor 11 to enter a conducting or non-conducting state. Specifically, as in one or more aforementioned embodiments, the first comparator 13-1 may generate a first comparison signal according to the comparison result between the voltage-divided or non-voltage-divided input signal Vin and the first reference signal Vr1. Meanwhile, the second comparator 13-2 may be electrically connected to any sensor through terminal N4 to receive a sensing signal V1, and may be electrically connected to a designated terminal on circuit through terminal N5 to receive a designated electrical signal V2, and generate a second comparison signal according to the sensing signal V1 and the designated electrical signal V2. When the logic element 14 determines that both the first comparison signal and the second comparison signal meet a preset condition, the logic element 14 may control the first transistor 11 to enter a conducting mode, otherwise, the logic element 14 controls the first transistor 11 to enter a non-conducting mode. In some embodiments, the preset condition that the logic element 14 uses to determine whether the first comparison signal and the second comparison signal may be set according to actual requirements, and the disclosure is not limited thereto.

Specifically, the input terminals of the second comparator 13-2 (i.e., terminals N4 and N5) may be electrically connected to a temperature sensor or a process parameter sensor to output the second comparison signal according to a temperature signal or a process parameter signal. For example, the aforementioned temperature sensor or process parameter sensor may be configured to sense a physical parameter (such as temperature value or pressure value), an electrical parameter (such as current value, voltage value, or resistance value), or a chemical parameter (such as pH value) of an embedded system, and the disclosure is not limited to these parameters. It should be noted that the inclusion of the second comparator 13-2 and the logic element 14 may add an additional judgment condition to prevent erroneous results that might occur when the first comparator 13-1 is solely used under a special situation. For instance, in a situation where the temperature is excessively high or excessively low, temperature variation may affect the comparison result of the first comparator 13-1, leading the first comparator 13-1 to determine that the voltage value of the voltage-divided or non-voltage-divided input signal Vin is not higher than the voltage value of the first reference signal Vr1, and directly turning on the first transistor 11, at this moment the disposition of the second comparator 13-2 and the logic element 14 may prevent causing damage to the back-end circuit. In some embodiments, the number, placement, and circuit configuration of the first comparator 13-1 and the second comparator 13-2 are merely examples. The present disclosure may also include a plurality of other comparators, or be combined with a plurality of logic elements to perform determination based on a variety of different preset conditions or the plurality of aforementioned parameters, in order that the plurality of logic elements control the first transistor 11 to enter a conducting state or a non-conducting state according to the comparison results of the comparison signals of the plurality of comparators, and the present disclosure is not limited thereto.

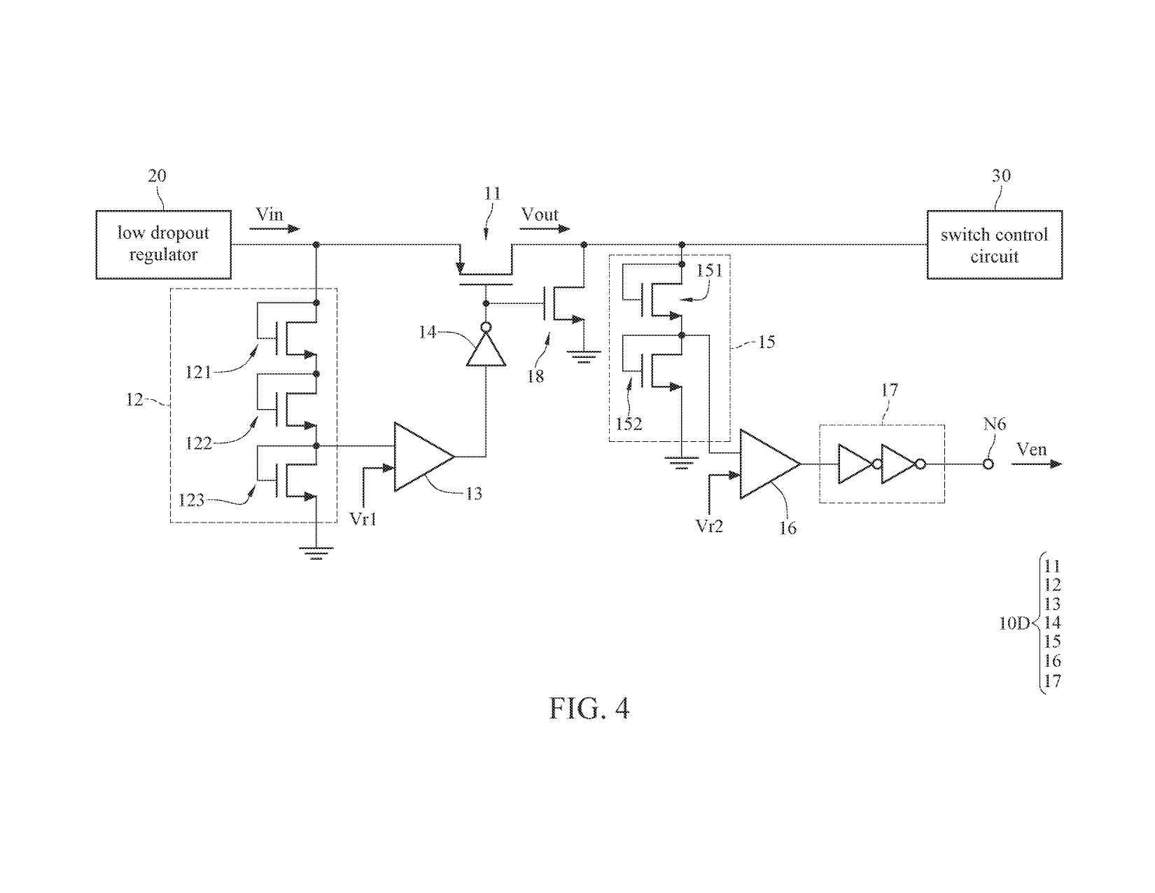

Please refer to FIG. 4, which is a circuit schematic diagram of a protection circuit 10D according to yet another embodiment of the present disclosure. As shown in FIG. 4, compared to the embodiments in FIG. 1 to FIG. 3, the protection circuit 10D of this embodiment may further include a second voltage-dividing sub-circuit 15 and a third comparator 16. The second voltage-dividing sub-circuit 15 is electrically connected to the second terminal of the first transistor 11, and is configured to perform voltage division on the output signal Vout. An input terminal of the third comparator 16 is electrically connected to the second voltage-dividing sub-circuit 15. Another input terminal of the third comparator 16 may be configured to receive a second reference signal Vr2. The third comparator 16 may be configured to output an activation signal Ven at terminal N6 of the protection circuit 10D according to a comparison result between the second reference signal Vr2 and the voltage- divided output signal Vout. It should be noted that the first comparator 13-1, the second comparator 13-2 in the aforementioned embodiments, and the third comparator 16 in this embodiment may be basically identical components, and each having two input terminals and an output terminal.

In some embodiments, the second voltage-dividing sub-circuit 15 may include a plurality of voltage-dividing elements connected to each other in series, and the third comparator 16 may be electrically connected to the plurality of aforementioned voltage-dividing elements. More specifically, these voltage-dividing elements may be a plurality of voltage-dividing transistors 151 and 152, and an input terminal of the third comparator 16 may be electrically connected between these voltage-dividing transistors 151 and 152. For example, the third comparator 16 in the embodiment of FIG. 4 is electrically connected between the voltage-dividing transistor 151 and the voltage-dividing transistor 152 to perform voltage division on the output signal Vout via the first transistor 11. In some embodiments, the number and the circuit configuration of voltage-dividing transistors within the second voltage-dividing sub-circuit 15 are not limited thereto, and may be adjusted based on actual requirements. Additionally, the configuration of the second voltage-dividing sub-circuit 15 may be referred to the first voltage-dividing sub-circuit 12 as described above, and the redundant description is omitted here. It is worth noting that although the third comparator 16 is similar to the first comparator 13, the third comparator 16 may output an activation signal Ven according to the comparison result between the voltage-divided output signal Vout and the second reference signal Vr2. However, in comparison to the first comparator 13, the purpose of the third comparator 16 is not configured to block the transient voltage but instead waits until the output signal Vout reaches a target voltage, and then outputting the activation signal Ven. As a result, the activation signal Ven may be prevented from being output when the output signal Vout is too low, thereby avoiding the situation of functional errors occurring in the back-end switch control circuit 30. In some embodiments, the number, position, and circuit configuration of the first comparator 13 and the third comparator 16 are merely examples, and the present disclosure may also include a plurality of other comparators, a plurality of other reference signals, or with a plurality of logic elements to perform determination to one or more different target voltages. The activation signal Ven is outputted after one or more different target voltages have been reached, and the disclosure is not limited thereto.

More specifically, the output terminal of the third comparator 16 of this embodiment may be further electrically connected to a logic element 17. In some embodiments, the logic element 17 may be an non-inverting buffer (or a buffer gate) formed by two inverters connected in series. In this case, the output signal of the non-inverting buffer is the same as the output signal of the third comparator 16, meaning that: the output signal of the non-inverting buffer may be "1" when the output signal of the third comparator 16 is "1"; the output signal of the non-inverting buffer may be "0" when the output signal of the third comparator 16 is "0". Thus, the protection circuit 10D may more conveniently generate the activation signal Ven in a digital logic way. The configuration of the logic element 17 may also be referred to the logic element 14 as described above, and redundant descriptions are omitted here.

Additionally, the protection circuit 10D of the embodiment may further include a second transistor 18. The second transistor 18 may be a metal-oxide-semiconductor field-effect transistor, and whose first terminal is the source, second terminal is the drain, and the control terminal is the gate. However, the second transistor 18 may also be other kinds of transistors, and the disclosure is not limited thereto. This first terminal of the second transistor 18 may be grounded. The second terminal of the second transistor 18 may be electrically connected to the second terminal of the first transistor 11, and the control terminal of the second transistor 18 may be electrically connected to the output terminal of the first comparator 13. Specifically, the control terminal of the second transistor 18 is electrically connected to the control terminal of the first transistor 11. In some embodiments, one of the first transistor 11 and the second transistor 18 is a P-type transistor, and the other is an N-type transistor. In some embodiments, the first comparator 13 along with the logic element 14 (which is an inverter in this case) may be configured to control the conducting states of the first transistor 11 and the second transistor 18. More specifically, due to the opposite polarities of the first transistor 11 and the second transistor 18, the second transistor 18 may be turned off when the first transistor 11 is turned on, and the second transistor 18 may be turned on when the first transistor 11 is turned off. With this circuit configuration of the second transistor 18, the second transistor 18 may be turned on before the first transistor 11 is turned on, ensuring that the output terminal (second terminal) of the first transistor 11 is grounded, thereby preventing the protection circuit 10D from outputting an erroneous voltage or having functional error. Furthermore, the second transistor 18 may be turned off when the first transistor 11 is turned on, ensuring that the output signal Vout is not affected.

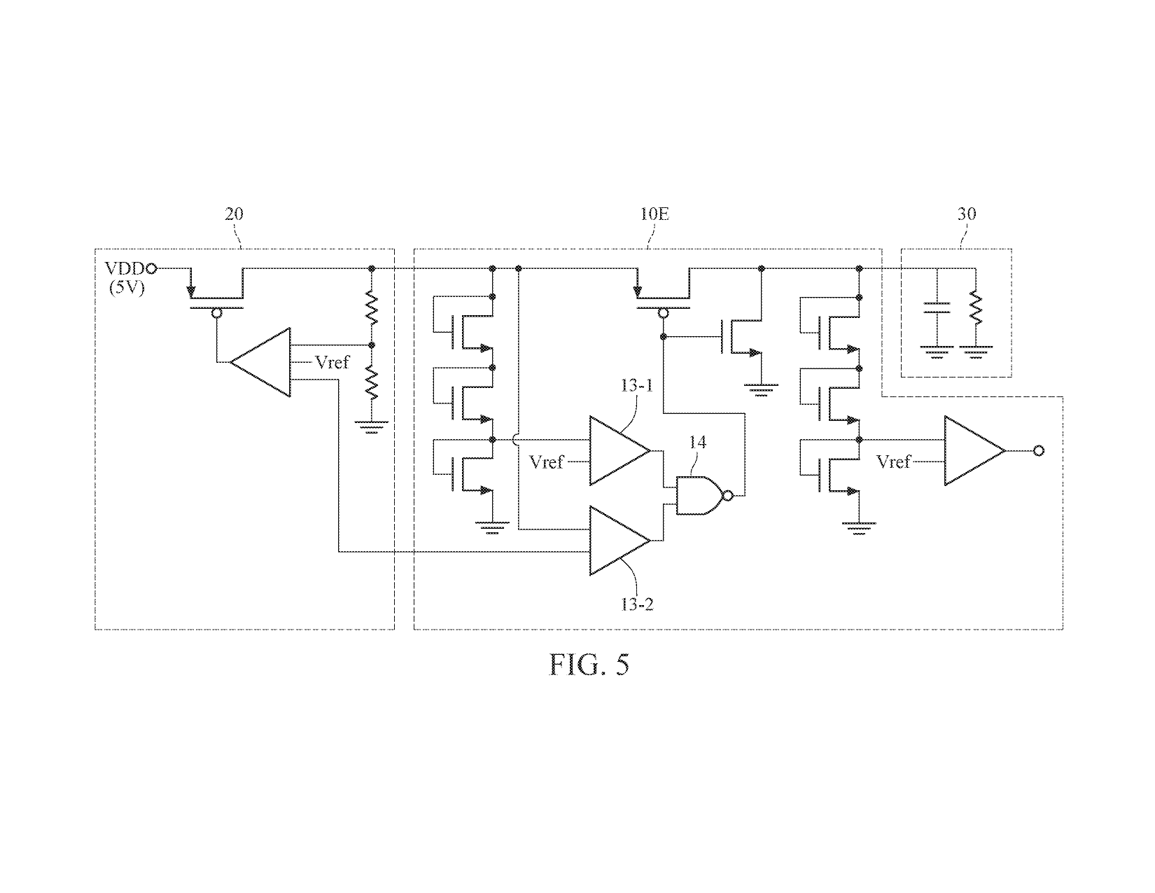

One or more embodiments of the present disclosure may be combined with each other. Please refer to FIG. 5 after combining the embodiments in FIG. 3 and FIG. 4. FIG. 5 is a circuit schematic diagram of a protection circuit 10E according to still another embodiment of the present disclosure. It is worth noting that the difference between the protection circuit 10E of this embodiment and the embodiment in FIG. 4 is that the first comparator 13-1, the second comparator 13-2 and the logic element 14 of the embodiment in FIG. 3 are incorporated. The description focus on the difference here, and the parts identical to the aforementioned embodiments are omitted or simplified. As shown in FIG. 5, the first comparator 13-1 of the embodiment may similarly be configured to generate a first comparison signal according to the voltage-divided input signal and the reference signal Vref. An input terminal of the second comparator 13-2 is electrically connected to the front-end low dropout regulator 20, and is configured to receive the output voltage signal of the low dropout regulator 20, and another input terminal of the second comparator 13-2 is electrically connected to the input terminal (first terminal) of the first transistor. It is worth noting that the input terminal of the second comparator 13-2 is coupled to the front-end low dropout regulator 20, which may reduce the influence caused by an external temperature variation and/or a process offset on the determination of the protection circuit 10E. At the same time, compared to the single comparator configuration in FIG. 4 (i.e., the first comparator 13), the accuracy of the protection circuit 10E in determining the output voltage signal of the low dropout regulator 20 may be improved. In some embodiments, when the logic element 14 determines that both the first comparison signal of the first comparator 13-1 and the second comparison signal of the second comparator 13-2 meet the preset condition, the logic element 14 may control the first transistor to enter the conducting mode, and control the second transistor to enter the non-conducting mode. Otherwise, the logic element 14 may control the first transistor to enter the non-conducting mode, and control the second transistor to enter the conducting mode.

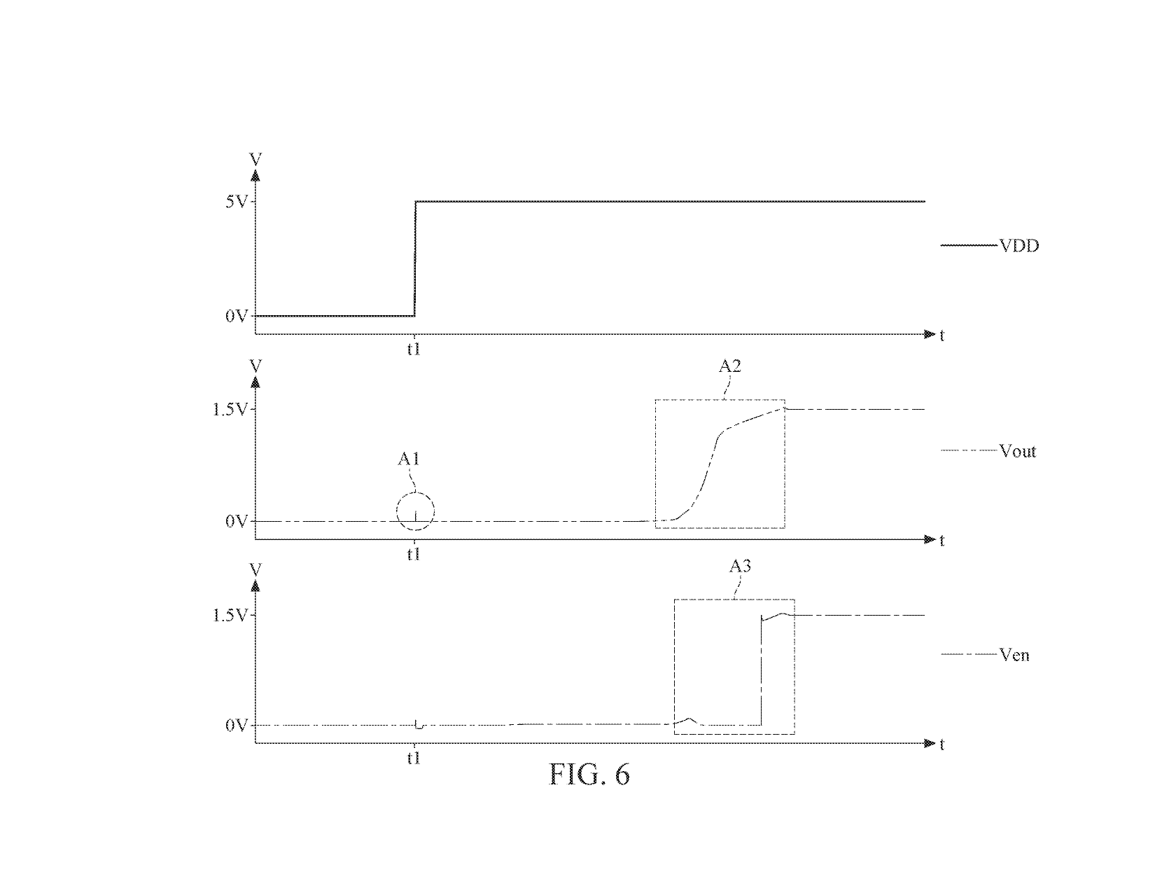

Please refer to FIG. 6, which schematically illustrates a response relationship among a power-on signal VDD, an output signal Vout, and an activation signal Ven of the protection circuit of the embodiments shown in FIG. 4 and FIG. 5. The vertical axis represents voltage (V), and the horizontal axis represents time (t). The power-on signal VDD may be assumed to be a stable signal provided by a battery to a low-dropout regulator, and the target voltage may be assumed to be 1.5V. As shown in FIG. 6, assuming that the power-on signal VDD with a voltage value of 5V activates the protection circuit at time point t1, at this moment due to the presence of the configuration of the aforementioned first comparator 13-1, enabling that the transient voltage generated by the output signal Vout at time point t1 to be very small (please refer to dashed area A1, and for example, the transient voltage is approximately 0.18V), preventing damage to the back-end circuit. After the activation of the power-on signal VDD, the output signal Vout starts to gradually increase to the voltage value 1.5V (please refer to dashed area A2). On the other hand, the activation signal Ven also rises to 1.5V over time, however, due to the configuration of the aforementioned third comparator 16, the activation signal Ven is suppressed close to 0V before reaching the target voltage of 1.5V, and then rapidly reaches the target voltage (please refer to dashed area A3). Therefore, the voltage of the activation signal Ven may be prevented from being at an insufficient voltage level below 1.5V during the rising process and resulting in a functional error of back-end circuit.

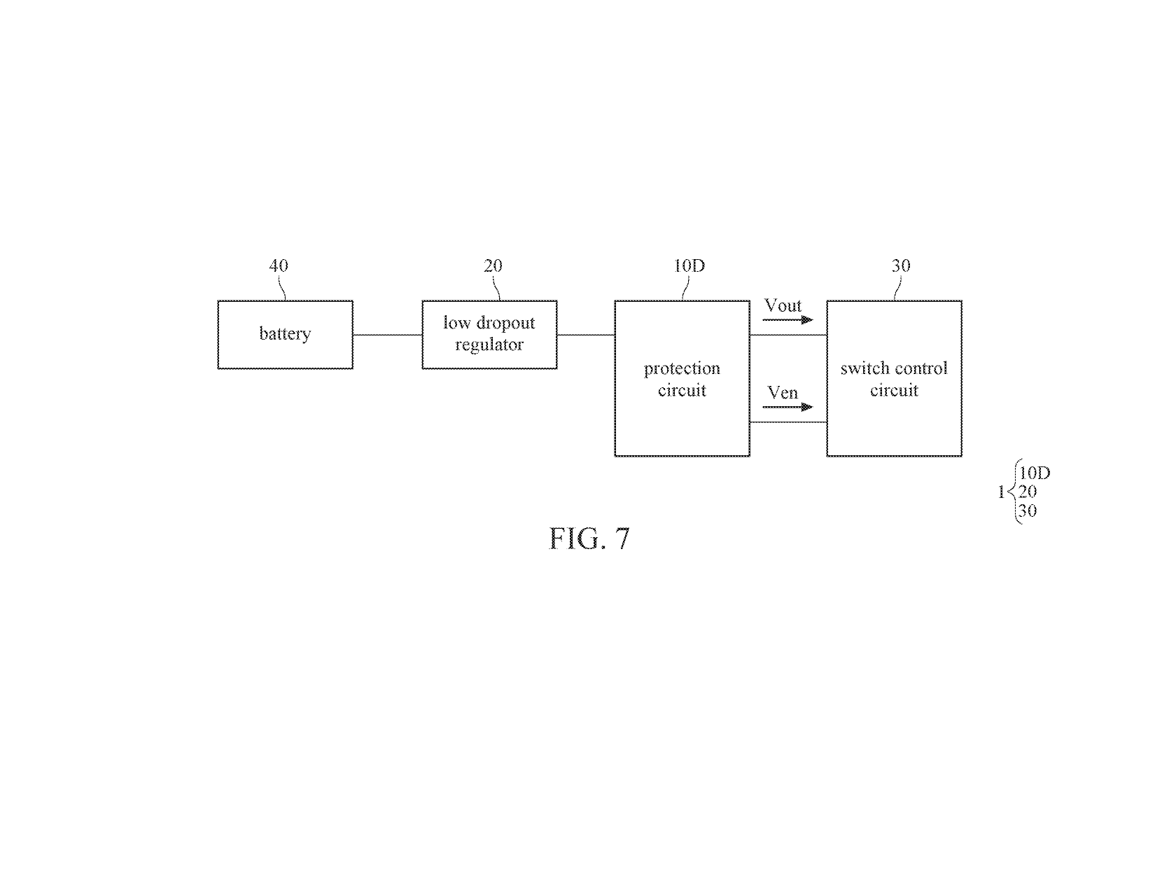

Please refer to FIG. 7, which is a functional block diagram of an embedded multi-chip system according to an embodiment of the present disclosure. As shown in FIG. 7, the embedded multi-chip system 1 may include the aforementioned protection circuit 10D (or any embodiment of the aforementioned protection circuit), a low dropout regulator 20, and a switch control circuit 30. The low dropout regulator 20 may be electrically connected to a battery 40, and is configured to generate and provide the aforementioned input signal to the first terminal of the aforementioned first transistor of the protection circuit 10D. The aforementioned switch control circuit 30 is electrically connected to the aforementioned protection circuit 10D, and is configured to control at least one switch element according to the aforementioned output signal Vout and the activation signal Ven. In some embodiments, the embedded multi-chip system 1 may be integrated into a package substrate, that is: the aforementioned protection circuit, power module (such as the aforementioned low dropout regulator 20 along with the battery 40), and an embedded multi-die active bridge (EMAB) chip may be integrated to achieve system miniaturization, and prevent the back-end switch control circuit 30 from having damage or functional abnormality.

In view of the above description, the protection circuit and embedded multi-chip system disclosed in the present disclosure utilize a first comparator to control the first transistor to stay in a conducting state or non-conducting state according to a comparison result between a first reference signal and an input signal. In this way, the transient voltage immediately generated by the low dropout regulator at the moment of power-on may be blocked to prevent the instantaneous high voltage from damaging the back-end circuit, thereby achieving the purpose of protecting the back-end switch control circuit. At the same time, the aforementioned first transistor staying in the conducting state or non-conducting state may further be determined collaboratively by an additionally disposed second comparator according to a plurality of judgement conditions (such as process parameters, temperature parameters, etc.), preventing erroneous judgments caused by a process or temperature variation in a single comparator. Additionally, a third comparator determines whether to output an activation signal according to a comparison result between a second reference signal and the aforementioned output signal voltage-divided by the voltage-dividing sub-circuit. In this way, the output voltage of the low dropout regulator may be output after rising to the target voltage, and the aforementioned activation signal may be output for a back-end circuit to read, so as to avoid the back-end circuit to have a malfunction due to the voltage being too low during the voltage rising process.

It will be apparent to those skilled in the art that various modifications and variations may be made to the disclosed embodiments. It is intended that the specification and examples be considered as exemplars only, with a true scope of the disclosure being indicated by the following claims and their equivalents.

What is claimed is:

1. A protection circuit, comprising:
a first transistor having a first terminal, a second terminal and a control terminal, and configured to receive an input signal through the first terminal and output an output signal through the second terminal in a conducting state; and
a first comparator, wherein an input terminal of the first comparator is coupled to the first terminal of the first transistor, another input terminal of the first comparator is configured to receive a first reference signal, an output terminal of the first comparator is coupled to the control terminal of the first transistor, and the first comparator is configured to output a first comparison signal according to a comparison result between the first reference signal and the input signal.

2. The protection circuit according to claim 1, further comprising a first voltage-dividing sub-circuit, connected to the first terminal of the first transistor and configured to perform voltage division on the input signal, wherein the first comparator outputs the first comparison signal according to the comparison result between the first reference signal and the input signal after the voltage division.

3. The protection circuit according to claim 2, wherein the first voltage-dividing sub-circuit comprises a plurality of voltage-dividing elements connected to each other, and the first comparator is connected to the plurality of voltage-dividing elements.

4. The protection circuit according to claim 3, wherein the plurality of voltage-dividing elements are a plurality of voltage-dividing transistors, and a gate and a drain of each of the plurality of voltage-dividing transistors are electrically connected to each other.

5. The protection circuit according to claim 1, further comprising an inverter connected to the output terminal of the first comparator and the control terminal of the first transistor, and the inverter is configured to control the first transistor to enter the conducting state or a non-conducting state according to the first comparison signal.

6. The protection circuit according to claim 1, further comprising a second comparator and a logic element, wherein the output terminal of the first comparator and an output terminal of the second comparator are connected to two input terminals of the logic element, respectively, the logic element is connected to the control terminal of the first transistor, and the logic element is configured to control the first transistor to enter the conducting state or a non-conducting state according to a comparison result between the first comparison signal from the first comparator and a second comparison signal from the second comparator.

7. The protection circuit according to claim 6, wherein an input terminal of the second comparator is connected to a temperature sensor or a process parameter sensor, to output the second comparison signal according to a temperature signal or a process parameter signal.

8. The protection circuit according to claim 1, further comprising:
a second voltage-dividing sub-circuit connected to the second terminal of the first transistor, and configured to perform voltage division on the output signal; and
a third comparator, wherein an input terminal of the third comparator is connected to the second voltage-dividing sub-circuit, another input terminal of the third comparator is configured to receive a second reference signal, and the third comparator is configured to output an activation signal according to a comparison result between the second reference signal and the output signal after the voltage division.

9. The protection circuit according to claim 8, further comprising a second transistor, wherein a first terminal of the second transistor is connected to the second terminal of the first transistor, a second terminal of the second transistor is grounded, and a control terminal of the second transistor is connected to the output terminal of the first comparator.

10. The protection circuit according to claim 9, wherein the control terminal of the second transistor is connected to the control terminal of the first transistor, and one of the first transistor and the second transistor is a P-type transistor, and the other of the first transistor and the second transistor is an N-type transistor.

11. An embedded multi-chip system, comprising:
a protection circuit, comprising:
a first transistor having a first terminal, a second terminal and a control terminal, and configured to receive an input signal through the first terminal and output an output signal through the second terminal in a conducting state; and
a first comparator, wherein an input terminal of the first comparator is coupled to the first terminal of the first transistor, another input terminal of the first comparator is configured to receive a first reference signal, an output terminal of the first comparator is coupled to the control terminal of the first transistor, and the first comparator is configured to output a first comparison signal according to a comparison result between the first reference signal and the input signal;
a low dropout regulator connected to a battery, and configured to generate and provide the input signal to the protection circuit; and
a switch control circuit connected to the protection circuit, and configured to control at least one switch element according to the output signal.

12. The embedded multi-chip system according to claim 11, wherein the protection circuit further comprises a first voltage-dividing sub-circuit connected to the first terminal of the first transistor and configured to divide the input signal, and the first comparator outputs the first comparison signal according to the comparison result between the first reference signal and the input signal which is divided.

13. The embedded multi-chip system according to claim 12, wherein the first voltage-dividing sub-circuit comprises a plurality of voltage-dividing elements connected to each other, and the first comparator is connected to the plurality of voltage-dividing elements.

14. The embedded multi-chip system according to claim 13, wherein the plurality of voltage-dividing elements are a plurality of voltage-dividing transistors, and a gate and a drain of each of the plurality of voltage-dividing transistors are electrically connected to each other.

15. The embedded multi-chip system according to claim 11, wherein the protection circuit further comprises an inverter connected to the output terminal of the first comparator and the control terminal of the first transistor, and the inverter is configured to control the first transistor to enter the conducting state or a non-conducting state according to the first comparison signal.

16. The embedded multi-chip system according to claim 11, wherein the protection circuit further comprises a second comparator and a logic element, the output terminal of the first comparator and an output terminal of the second comparator are connected to two input terminals of the logic element, respectively, the logic element is connected to the control terminal of the first transistor, and the logic element is configured to control the first transistor to enter the conducting state or a non-conducting state according to a comparison result between the first comparison signal from the first comparator and a second comparison signal from the second comparator.

17. The embedded multi-chip system according to claim 16, wherein an input terminal of the second comparator is connected to a temperature sensor or a process parameter sensor, to output the second comparison signal according to a temperature signal or a process parameter signal.

18. The embedded multi-chip system according to claim 11, wherein the protection circuit further comprises:
a second voltage-dividing sub-circuit connected to the second terminal of the first transistor, and configured to perform voltage division on the output signal; and
a third comparator, wherein an input terminal of the third comparator is connected to the second voltage-dividing sub-circuit, another input terminal of the third comparator is configured to receive a second reference signal, and the third comparator is configured to output an activation signal according to a comparison result between the second reference signal and the output signal after the voltage division.

19. The embedded multi-chip system according to claim 18, wherein the protection circuit further comprises a second transistor, a first terminal of the second transistor is connected to the second terminal of the first transistor, a second terminal of the second transistor is grounded, and a control terminal of the second transistor is connected to the output terminal of the first comparator.

20. The embedded multi-chip system according to claim 19, wherein the control terminal of the second transistor is connected to the control terminal of the first transistor, and one of the first transistor and the second transistor is a P-type transistor, and the other of the first transistor and the second transistor is an N-type transistor.
